(19) United States
(12) Patent Application Publication
(10) Pub. No.: US 2007/0296706 A1
(43) Pub. Date: Dec. 27, 2007

(54) Luminous keyboard module

(75) Inventors: Ching-Cheng Wang, Tao Yuan Shien (TW); Yi-Chun Lin, Taipei Shien (TW); Wen-Ji Tsai, Taipei Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/806,914

(22) Filed: Jun. 5, 2007

(30) Foreign Application Priority Data
Jun. 23, 2006 (TW) 95122830

(51) Int. Cl. G09G 3/34

(52) U.S. Cl. 345/170

(57) ABSTRACT

A luminous keyboard module uses a luminous material to produce keys of the keyboard module, or uses the luminous material to produce a backlight plate under the keys. When an UV light source irradiates UV light on the keys or the backlight plate containing the luminous material, the keys or the backlight plate can illuminate visible light to show the character symbols on the corresponding keys clearly under environment with insufficient light.

### CROSS-REFERENCE TO RELATED APPLICATION

This application claims priority to Taiwan Application Serial Number 95122830, filed Jun. 23, 2006, which is herein incorporated by reference.

### BACKGROUND

1. Field of Invention

The present invention relates to an input device. More particularly, the present invention relates to a luminous keyboard module.

2. Description of Related Art

Under an environment with insufficient light, such as a laboratory, a coffee shop, or a meeting room, character symbols on keys of a notebook computer keyboard are hard to be recognized. Many solutions have been provided to solve this problem.

In one solution, a reading light is mounted on a monitor of a notebook computer. Although the production cost is low, battery lifetime is reduced because power is also consumed by the reading light. Moreover, the illuminating angle of the reading light needs to be adjusted to avoid light directly illuminating on viewer's eyes. Furthermore, it is preferable to have light-colored character symbols on deep-colored keys so character symbols are easily visualized.

In another solution, a fluorescent paint is used to print character symbols on the keys of the notebook computer. Therefore, fluorescent paint can be irradiated with regular light and fluorescence will thus be generated from character symbols of keys. Although the production cost is low and the additional processing is simple, the intensity of the fluorescence is limited and the key surfaces as well as character symbols are easily scratched.

In yet another solution, one or more LEDs are used as light sources. Light generated by LEDs is conducted by many optical fibers disposed in a keyboard to light up the whole keyboard. Although its light intensity and lifetime are acceptable, lower mechanical strength of the keyboard is unavoidable due to holes in the keyboard are necessary for light propagation. Moreover, the height of the keyboard and the production cost are increased. That is why this solution is not popular.

In yet another solution, an electroluminescent (EL) material can be used as a light source. The features include power saving, higher light intensity, simple additional processing, cheap cost, and high impact toughness. However, the lifetime of the EL material is reduced due to high working temperature of the notebook computer, and the production cost is increased due to extra driving circuits required for EL material. Moreover, EL material usually contains phosphorous which causes environmental pollution problems.

In yet another solution, LEDs are disposed in four corners of the keyboard, and a light guide plate is used to guide light generated by the LEDs. Light can be softened and the structure of light guide plate is simple. However, holes are also required in the keyboard to allow light propagation, and longer adjusting time in product development is needed to obtain a uniform light intensity over the keyboard.

In yet another solution, each key has a LED therein as the light source. Although light intensity is strong, but many light spots are produced to irritate user's eyes. Moreover, the production cost is greatly increased, and more power is consumed by LEDs.

### SUMMARY

According to an embodiment, a luminous keyboard module is provided. The luminous keyboard module comprises a base, keys disposed on the base, and a light source positioned to illuminate UV light on the keys. Each of the keys has a corresponding character symbol thereon, and the character symbol is made by a luminous material. The UV light generated by the light source illuminates on the keys to enable the luminous material to irradiate visible light. The light source can be disposed on a monitor or a body of a computer.

According to another embodiment, another luminous keyboard module is provided. The luminous keyboard comprises a base, keys disposed on the base, a backlight plate disposed between the base and the keys, and a light source disposed in the base and positioned to illuminate UV light on the backlight plate. The light source can be disposed under the backlight plate or on a lateral side of the backlight plate. The UV light generated by the light source illuminates on the backlight plate containing a luminous material to enable the luminous material to irradiate visible light.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a diagram showing a luminous keyboard module applied on a notebook computer according to an embodiment of this invention;

FIG. 1B is a local cross-sectional view of the luminous keyboard module in FIG. 1A;

FIG. 1C is a local top-view of the luminous keyboard module in FIG. 1A;

FIG. 2A is a local cross-sectional diagram of another luminous keyboard module according to another embodiment of this invention; and

FIG. 2B is a local cross-sectional diagram of another luminous keyboard module according to another embodiment of this invention.

### DETAILED DESCRIPTION

### Embodiment 1

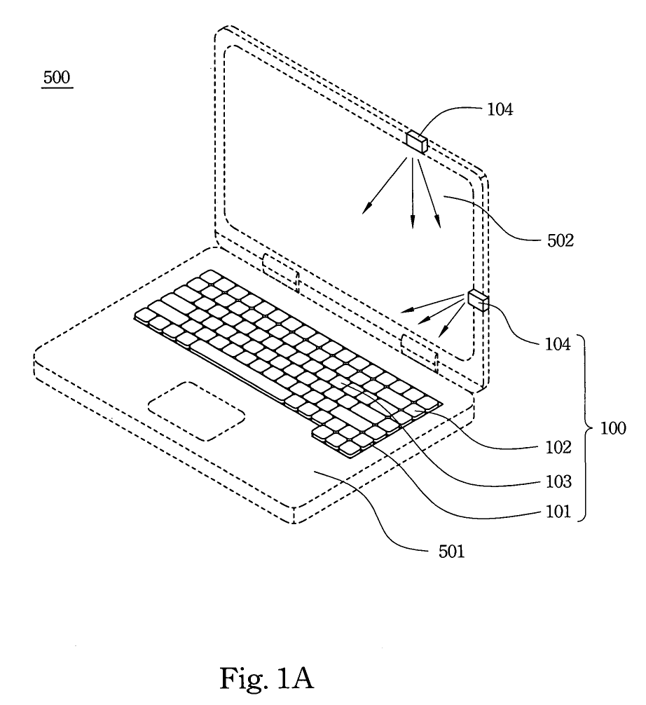

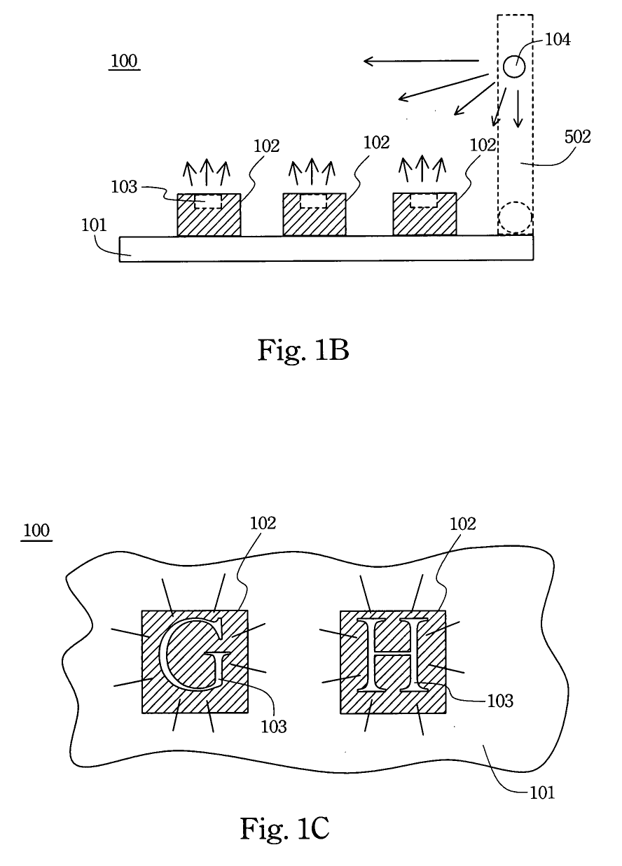

FIG. 1A is a diagram showing a luminous keyboard module applied on a notebook computer according to an embodiment of this invention. In FIG. 1A, a notebook computer 500 comprises a bottom housing 501, which comprises a motherboard, a central processing unit, and etc., a monitor 502, and a luminous keyboard module 100.

FIG. 1B is a local cross-sectional view of the luminous keyboard module in FIG. 1A, and FIG. 1C is a local top-view of the luminous keyboard module in FIG. 1A. In FIGS. 1B and 1C the keyboard module 100 comprises a base 101, plural keys 102 and a light source 104. The base 101 is disposed in the bottom housing 501 (in FIG. 1A), and the keys 102 are disposed on the base 101.

Each key 102 has a corresponding character symbol 103 thereon. The character symbols 103 can be made by a luminous material, such as a fluorescent material, a phosphorescent material, or a combination thereof. For example, the fluorescent material can be a stilbene compound or a derivative thereof; the phosphorescent material can be a sulfide compound such as ZnS.

The keys 102 having the character symbols 103 made by luminous material can be manufactured by bi-injection molding. Since the luminous material is a part of the keys 102, rather than print on the keys, the character symbols 103 are durable and can be recognized easily.

The light source 104 can be mounted on any place that can illuminate UV light on the keys 102 to enable the luminous material to irradiate visible light. For example, the light source 104 can be mounted on the top or right/left side of the monitor 502 (in FIG. 1A), or at any suitable place in the bottom housing 501. The light source 104 can generate UV light with wavelengths of 320-400 nm (UV-A). In one embodiment, the light source can generate UV light in wavelengths of 360-380 nm.

The light source 104 can be a black-light tube, a type of small UV tube, or an UV LED. For example, the black-light tube can be a commercial product, F4T5/BLB, manufactured by Philips or Osram; the UV LED can be a commercial product NSHU550A, NSHU590A, NSHU550B, or NSHU550B manufactured by Nichia. The harmful UV light (UV-B, in 280-320 nm, and UV-C, less than 280 nm) can be filtered by a plating layer in the UV tube or a package material of the LED.

Therefore, under such arrangement, the character symbols 103 on the keys 102 can irradiate visible light under the UV light generated by the light source 104. User can recognize the character symbols 103 very easily under an environment with insufficient light.

### Embodiment 2

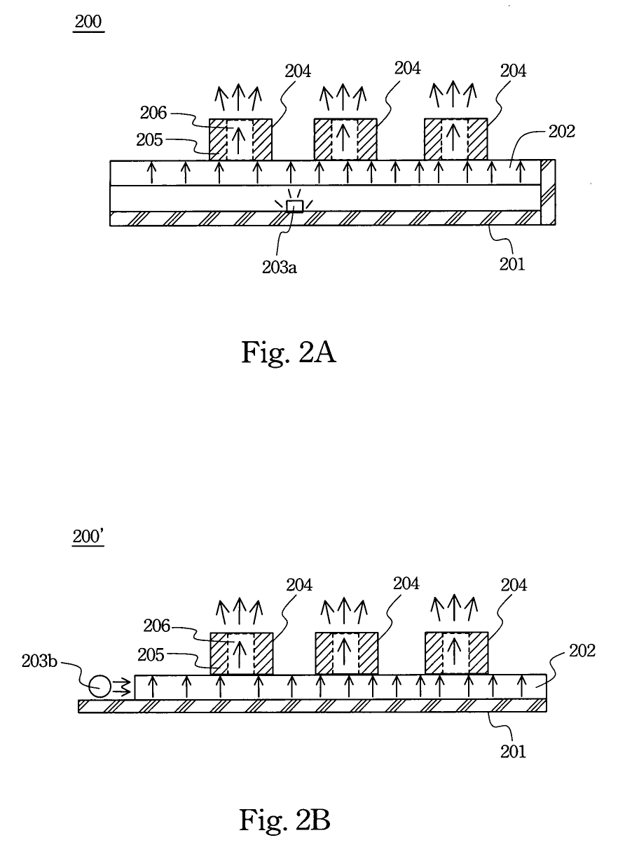

FIGS. 2A-2B are local cross-sectional diagrams of another two various luminous keyboard modules according to another embodiment of this invention. In FIGS. 2A-2B, the keyboard module 200 or 200′ includes a base 201, a backlight plate 202, a light source 203a or 203b, and plural keys 204.

The backlight plate 202 is disposed in the base 201 and positioned under the keys 204. The light source 203a or 203b can be disposed in the base 201 and positioned under the backlight plate 202, as shown in FIG. 2A, or positioned on a lateral side of the backlight plate 202, as shown in FIG. 2B. The keys 204 are disposed on the base 201. Each key 204 has at least an opaque cap 204 and a transparent character symbol 206, which can be made by bi-injection molding.

The raw materials of the backlight plate 202 include a luminous material, such as a fluorescent material, a phosphorescent material, or a combination thereof. For example, the fluorescent material can be a stilbene compound or a derivative thereof; the phosphorescent material can be a sulfide compound, such as ZnS. The luminous material can be blended into a matrix material, such as a polymer or other suitable materials, and then form the backlight plate 202. If the matrix material is a polymer, such as an acrylic resin, the backlight plate 202 can be made by injection molding.

The light source 203a or 203b can be a black-light tube, a type of small UV tube, or an UV LED. For example, the black-light tube can be a commercial product, F4T5/BLB, manufactured by Philips or Osram; the UV LED can be a commercial product NSHU550A, NSHU590A, NSHU550B, or NSHU550B manufactured by Nichia. The harmful UV light (UV-B, in 280-320 nm, and UV-C, less than 280 nm) can be filtered by a plating layer in the UV tube or a package material of the LED.

Since the backlight plate 202 comprises a luminous material, the backlight plate 202 can irradiate visible light under the UV light illumination of the light source 203a or 203b. The visible light irradiated by the backlight plate 202 can then penetrate the transparent character symbols 206 of the keys 204. Hence, user can recognize the character symbols 206 clearly under environment with insufficient light.

According to the embodiments of this invention, several luminous keyboard modules are provided to allow user to easily recognize the character symbols of the keys under environment with insufficient light without increasing much production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A luminous keyboard module, comprising:
a base;
plural keys disposed on the base, each of the keys having a character symbol made by a luminous material thereon; and
a light source for illuminating UV light, with wavelengths of 320-400 nm, on the keys to enable the luminous material to irradiate visible light.

2. The luminous keyboard module of claim 1, wherein the light source is a light emitting diode.

3. The luminous keyboard module of claim 1, wherein the light source is a black-light tube.

4. The luminous keyboard module of claim 1, wherein the light source is disposed on a monitor of a computer.

5. The luminous keyboard module of claim 1, wherein the light source is disposed in a housing of a computer.

6. The luminous keyboard module of claim 1, wherein the luminous material is a fluorescent material, a phosphorescent material, or a combination thereof.

7. The luminous keyboard module of claim 6, wherein the fluorescent material comprises a stilbene compound or a derivative thereof.

8. The luminous keyboard module of claim 6, wherein the phosphorescent material comprises a sulfide.

9. The luminous keyboard module of claim 8, wherein the sulfide comprises zinc sulfide.

10. A luminous keyboard module, comprising:
a base;
plural keys disposed on the base, each of the keys having a character symbol that is pervious to light;
a backlight plate disposed in the base and under the keys, the backlight plate comprising a luminous material; and
a light source disposed in the base for illuminating UV light, with wavelengths of 320-400 nm, on the backlight plate to enable the backlight plate to irradiate visible light transiting through the character symbols of the keys.

11. The luminous keyboard module of claim 10, wherein the light source is a light emitting diode.

12. The luminous keyboard module of claim 10, wherein the light source is an UV lamp.

13. The luminous keyboard module of claim 10, wherein the light source is disposed under the backlight plate.

14. The luminous keyboard module of claim 10, wherein the light source is disposed on a lateral side of the backlight plate.

15. The luminous keyboard module of claim 10, wherein the luminous material is a fluorescent material, a phosphorescent material, or a combination thereof.

16. The luminous keyboard module of claim 15, wherein the fluorescent material comprises a stilbene compound or a derivative thereof.

17. The luminous keyboard module of claim 15, wherein the phosphorescent material comprises a sulfide.

18. The luminous keyboard module of claim 17, wherein the sulfide comprises zinc sulfide.
